(19) United States
(12) Patent Application Publication
(10) Pub. No.: US 2014/0237608 A1
(43) Pub. Date: Aug. 21, 2014

(54) System and Method for Masking Email Addresses

(71) Applicants: TIM PRIER, Overland Park, KS (US); William Dugan, Overland Park, KS (US); Yuen Ho, Overland Park, KS (US)

(72) Inventors: TIM PRIER, Overland Park, KS (US); William Dugan, Overland Park, KS (US); Yuen Ho, Overland Park, KS (US)

(21) Appl. No.: 13/768,201

(22) Filed: Feb. 15, 2013

(51) Int. Cl. H04L 29/06

(52) U.S. Cl. CPC H04L 63/20
USPC 726/26

(57) ABSTRACT

The present invention is directed to a system and method for masking email addresses. In an exemplary embodiment, a consumer responds to a marketing offer by supplying consumer information, including an actual email address, to a lead specialist. The consumer's actual email address is masked, with a unique email address substituted, when the consumer's information is passed-on to a lender. The lead specialist can then track and filter responses to the consumer to identify misuse of its lead information and to protect the consumer from unwanted emails and solicitations.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

The present invention is generally directed to the field of marketing and, more specifically, to a method for optimizing the delivery of marketing offers in a marketing campaign.

2. Description of Related Art

1. Field of the Invention

The present invention is generally directed to the field of email delivery, and more specifically, to a method for masking email addresses to protect consumer information.

2. Description of Related Art

Consumer demand for credit services is ever-increasing, each year the consumer loan and credit card industry alone provides hundreds of billions of dollars in credit to consumers. Consumers often seek out direct credit opportunities themselves, relying on websites or other Internet promotional advertisements to apply for loans or other credit products, or to simply request additional information about available products. That promotional information is often provided by a lead specialist which offers lenders expertise in selecting and targeting advertising to desired consumers based on demographics, past response to marketing offers, or various other selection criteria. When a consumer responds to an offer, or enters information at a website, the lead specialist selectively passes that information (including the consumers' email address) to various client lenders who may be able to offer the consumer a loan or other credit product. In return, the lenders typically pay the lead specialist a fee, and typically agree to not make use of the lead information to make other offers directly to the consumer.

In practice, however, some lenders disregard that agreement and target other offers directly to the consumer, or even sell or make available the consumers' contact information to others, resulting in the consumers' disclosed email address being inundated with additional offers. Thus, both the lead specialist and consumers are adversely affected by the unauthorized use of consumers' email addresses.

### BRIEF SUMMARY OF THE INVENTION

The present invention is directed to a system and method for masking an email address in a manner that masks a consumer's actual email address and that protects a lead specialist from misuse or theft of lead information, while still allowing permitted email communication with the consumer.

In an exemplary embodiment, a lead specialist receives information from a consumer in response to a web page, email, or other advertising or promotional vehicle. Included in that consumer information is the consumer's actual email address, that is, the email address provided by the consumer. Prior to passing the consumer's information on to one or more lenders, the lead specialist masks the consumer's actual email address, and substitutes a different, unique email address that resolves to a domain name or email system controlled by the lead specialist. For example, lead specialist ABC Company may mask a consumer's actual email of consumer@emailprovider.com, substituting a unique email of consumer@abccompany.com (with the “abccompany.com” domain name being in the control of ABC Company) prior to sending the consumer's information on to any lenders. The lead specialist maintains a database of the consumer's actual email address (along with the other collected consumer information), and the unique email address (or addresses) assigned to that particular consumer so that the actual email addresses and any assigned unique email addresses are correlated to the particular consumer.

After sending the information including the masked email to the lenders, the lead specialist is then positioned to monitor and direct subsequent email correspondence to that unique email address. Thus, for example, valid emails from lenders to the consumer relating to the original offer could be passed-on to the consumer by correlating the unique email address at which the message is received to the consumer's actual email address, and directing the email to the consumer at that actual email address. Emails from lenders that do not relate to the original offer, such as unauthorized marketing offers that bypass the lead specialist, can be filtered out and not delivered to the consumer.

Thus, the consumer is protected from unsolicited offers from lenders (or from others if unscrupulous lenders sell or pass-on the consumer's email information), and is protected from having their actual email address widely distributed. Likewise, the lead specialist is protected from misuse and theft of consumer contact information.

It should be understood that while the claimed invention is described primarily with reference to the field of consumer lending, the same email masking system and method may be applied to any field or vertical market where a lead specialist has proprietary contact information for consumers of any type of product and desires to protect that contact information and to protect those consumers from unwanted email correspondence.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a block diagram of an exemplary system for processing consumer information and masking emails in accordance with the present invention.

FIG. 2 is a block diagram of the lead specialist of FIG. 1.

FIG. 3 is a block diagram of a consumer information data record in accordance with an exemplary embodiment of the present invention.

FIG. 4 is a flow diagram of an exemplary method for masking email addresses in accordance with an exemplary embodiment of the present invention.

FIG. 5 is a flow diagram of an exemplary method for processing a received email in accordance with an exemplary embodiment of the present invention.

### DETAILED DESCRIPTION OF EXEMPLARY EMBODIMENTS

The present invention is directed to a system and method for masking a consumer's actual email address to protect the consumer and lead specialist from misuse of that email address. While the system and method will be described herein with reference to an exemplary use in the consumer loan field, it should be understood that the claimed system and method is not limited to that field, and may equally be employed in auto loan or other lending services, credit card, and any other vertical markets in which consumers are targeted with marketing offers.

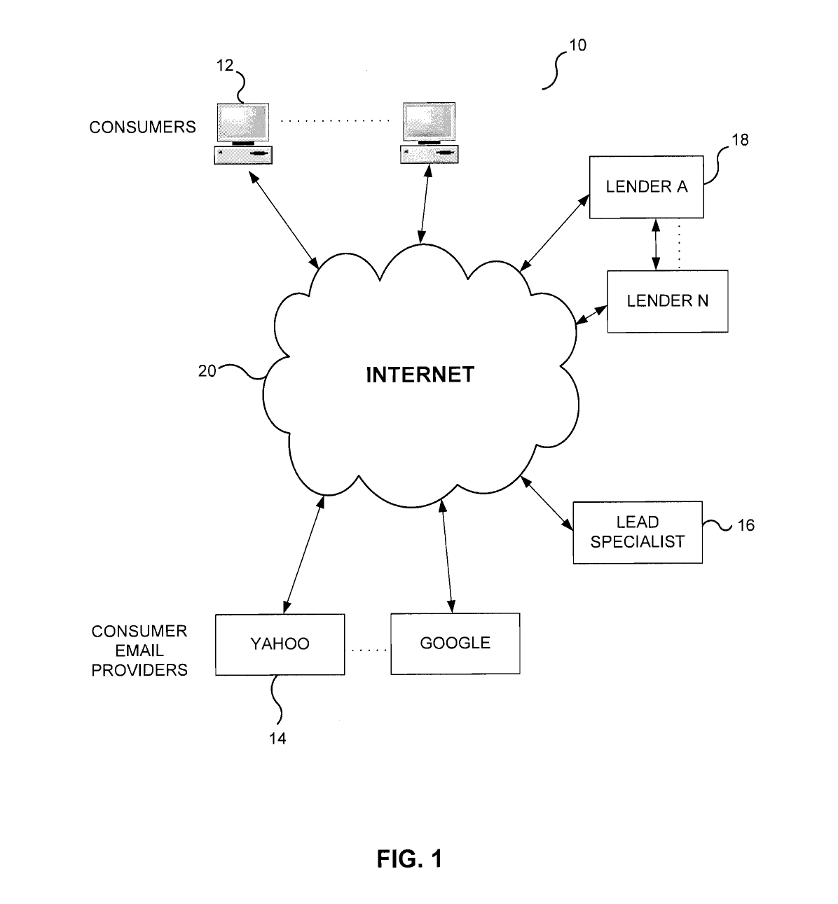

Referring first to FIG. 1, an exemplary system for masking emails in accordance with the present invention is referred to generally as reference numeral 10. Users of the system includes a plurality of consumers 12 (e.g., consumers interested in loan products), a plurality of consumer email providers 14 (e.g., providers of email services to consumers, such as Yahoo, Gmail, or Internet Service Providers (ISPs)), a lead specialist 16 (e.g., a specialist in the field of targeting marketing offers to consumers based on various demographic and other data), and a plurality of lenders 18 (e.g., consumer loan companies, banks, or the like), all in communication via links to the Internet 20.

Consumers 12 are typically consumers of loan products, credit cards, or other consumer loan products. These users access the Internet via personal computers, tablet computers, smartphones, or other communications devices. That access provides them access to their email, for example access to a consumer email provider 14, and access to the World Wide Web where they can view websites, including offers for consumer loan products provided by a lead specialist. Consumer email providers 14 are typically web or ISP based email providers that provide an email address and service to consumers. Thus, for example, consumers 12 can access their email accounts at consumer email providers 14 through a connection to the Internet 20. Lead specialist 16 is a provider of consumer lead information to lenders 18. For example, lead specialist 16 may post advertisements for consumer loan products at Web sites, or via directly targeting consumers via email, based on a database of consumer information aggregated by the lead specialist. When a consumer responds to such an advertisement, the lead specialist receives information from the consumer, and forwards or directs that information to one or more lenders based on a set of rules or protocols, for example selecting a lender based on the amount of money to be lent, or any number of other criteria. Lenders 18 ultimately may lend the consumer money, and enter into an agreement with the consumer for the loan. These users are exemplary of the users involved in the claimed system and method, it should be understood that any particular transaction may involve a single consumer, a single consumer email provider, and multiple lenders, or that the specific lenders involved for a transaction may vary depending on the particular consumer using the system.

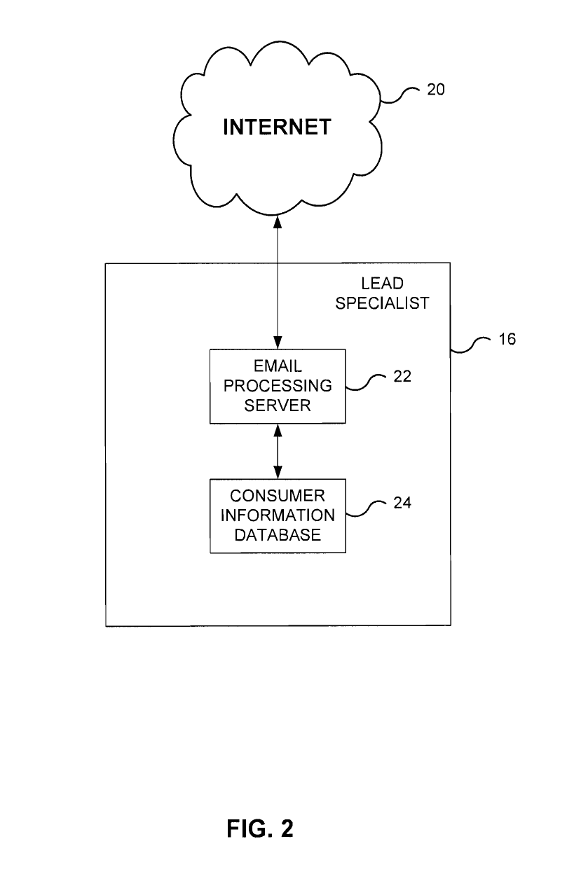

FIG. 2 depicts an exemplary block diagram of the lead specialist portion of the system of FIG. 1. The lead specialist 16 includes an email processing server 22 in communication with the Internet 20 and also in communication with a consumer information database 24. Email processing server 22 is operable to direct the flow of incoming and outgoing emails to/from the lead specialist, and in conjunction with defined rules and protocols as will be discussed in more detail below. Consumer information database 24 is operable to store on a storage device information received from a consumer in response to a marketing offer presented by the lead specialist to the consumer.

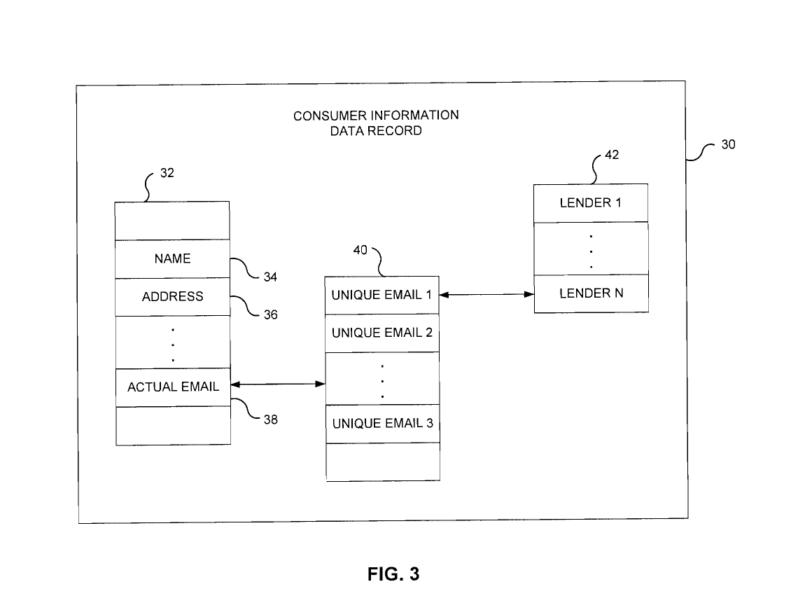

As shown in FIG. 3, an exemplary consumer information data record 30 includes a consumer's personal information 32, such as their name 34, address, 36, and actual email address 38. Also stored as part of the consumer's personal information may be their social security number, employment history, address history, credit history, and other information provided by the consumer to qualify for and obtain a consumer loan, i.e., information relating to a full credit application. As will be explained in more detail below, associated with a consumer's actual email address is one or more unique email addresses 40 assigned by the lead specialist and associated with the actual email address 38, or otherwise associated with the particular consumer's data record. Similarly, associated with each unique email address is a record of one or more lenders 42 with which the associated unique email address has been used for correspondence (as will be explained in more detail below).

It should be noted that the system of the present invention is described herein with reference to the terms “server”, “storage device”, and “database.” It should be understood that as used herein (including in the claims) the term “server” may mean either a single server or processor that performs the described processes or a plurality of servers that collectively perform the described processes; the term “storage device” means either a single storage device that stores the described database(s) or a plurality of storage devices that collectively store the described database(s); and the term “database” means either a single database that contains the described data or a plurality of databases that collectively contain the described data. Thus, the system and method may be implemented with any number of server(s), storage device(s) and database(s) without departing from the scope of the present invention. It should also be understood that the computer-implemented instructions for the claimed method are preferably stored on a non-transient computer-readable medium and may be stored on a storage device in a manner similar to the database information.

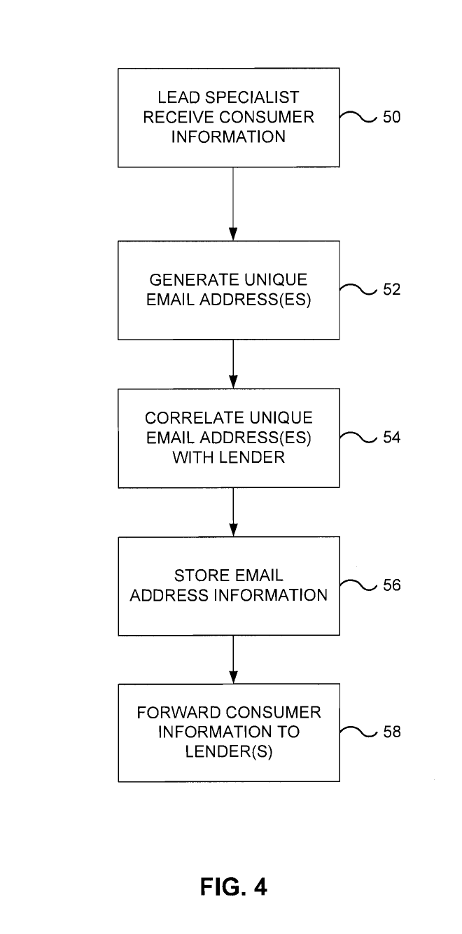

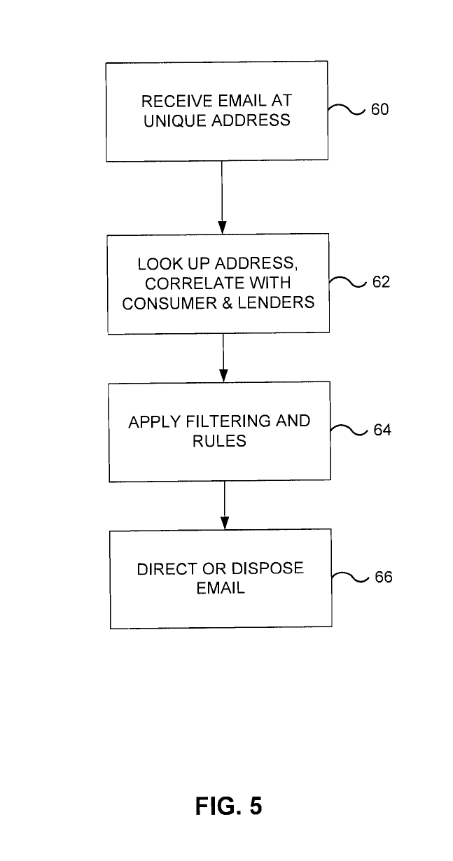

With the basic system set forth, an exemplary method for masking an email address in accordance with the present invention will now be described with reference to the flow diagrams of FIGS. 4 and 5, with further reference to the system components set forth in FIGS. 1-3. It should be noted that the exemplary system and method described illustrate the masking of an email address in accordance with the present invention. However, the invention is not limited to the specific steps and components described, and variations from the described examples are within the scope of the present invention.

Referring to FIG. 4, at block 50 a lead specialist receives consumer information from a consumer. The received email is processed though the lead specialists email processing server, as previously described. Typically, the consumer information received is in response to an advertisement or marketing offer placed by the lead specialist and presented to the consumer on a Web page or via a targeted email to that consumer. The consumer information received includes, at a minimum, the consumer's name and email address, In the case of a response to an offer of a consumer loan product, the consumer information received typically includes more detailed financial information, essentially all of the information required for a full credit application.

At block 52, the lead specialist, via the email processing server, masks the consumer's actual email by generating one or more unique email addresses correlated with that actual email address. For example, a consumer's actual email address of consumer@emailprovider.com could be translated to consumer@abccompany.com (where abccompany.com is a domain controlled or owned by the lead specialist). Additional unique email addresses may also be created based on variations of the consumer's actual email address—for example cnue@abccompany.com (taking alternate letters from the consumer's actual email address), conmer@abccompany.com (taking the first and last three letters from the consumer's actual email address), or c.sumer@abccompany.com (taking a first initial and last name from the consumer's actual email address). The lead specialist may use algorithms to derive various combinations or permutations of unique email addresses based on the consumer's actual email address, or may generate random or pseudorandom email addresses either based on, or independently of, the consumer's actual email address. Thus, for example, a unique email generated for consumer@emailprovider.com may be zq123@abccompany.com—i.e., the unique email address bears no visible relationship to the actual email address. In addition to generating a unique email name, the lead provider preferably has control of numerous domain names, e.g., xyzcompany.com, qrscompany.com, etc. Thus, in combination with generating a unique email name, the lead specialist can also associate one of many domain names with that email name, so, for example, unique emails of cnue@abccompany.com, cnue@xyzcompany.com, etc can be generated. In the case of a lead specialist having one-thousand domain names under its control, it can be seen that in combination with a defined, random, or pseudorandom email name that a virtually infinite number of unique email addresses can be generated for association with a consumer's actual email address. Preferably, the email processing server verifies that a generated email address is unique, and has not been assigned or associated with a consumer already. In alternative embodiments, the unique email s may have an expiration so that the address expires or is disabled after a period of time, so that later-occurring correspondence will be undeliverable. The unique email address can thus function as a one-time-use or throwaway address. In addition, unique email addresses may be re-used after a period of time by being unassociated with the initial consumer record to which they were correlated, and assigned to a new consumer record.

At block 54, the email processing server correlates the one or more unique email addresses generated for a particular consumer with one or more lenders who will be recipients of that consumer's information. The method of the present invention anticipates numerous scenarios for use of the unique emails associated with the consumer to mask the consumer's actual email address. In one exemplary embodiment, a single unique email can be substituted for the consumer's actual email address when sending the consumer information to a plurality of lenders. In that case, each lender receives the consumer's information with the same unique email address for that consumer. In another exemplary embodiment, multiple unique emails are generated, one for each of multiple lenders that will be receiving the consumer's information. In that case, the consumer information received by each lender will be identical, except for the consumer's email address. Other variations are possible, for example, lenders may be divided into various groups, with a first group of lenders receiving consumer information having a first unique email address associated with the consumer, a second group of lenders receiving consumer information having a second unique email address associated with the consumer, and so forth. In any case, the consumer's actual email address is masked from the lender, the lender receives only a unique email address that the lead specialist has associated with the consumer's actual email address, and/or the consumer's information data record.

Turning to block 56 of FIG. 4, with one or more of the unique email addresses associated with one or more lenders, as just described information regarding the unique email address(es) and the associated lender(s) is stored in the database, preferably also correlated with the other information submitted by the consumer. For example, looking to FIG. 3, a consumer's information data record 30 comprises a consumer's personal information 32, including their actual email address 38. That actual email address is correlated with one or more unique email addresses 40 as described above, those unique email addresses are further correlated with one or more lenders 42, with the entire data record stored in the database.

At block 58 of FIG. 4, the consumer's information is forwarded to one or more lenders for consideration of the consumer's request for a loan. As just described, each lender may receive the consumer's information with the consumer's actual email address masked from the lender and replaced with a single unique email address, or each lender may receive the consumer's information with a unique email address sent only to that particular lender. Preferably, the consumer information is sent to the lenders in an encrypted format.

With the unique emails generated as described above, the consumer's actual email is masked from view of the lenders, preventing the lenders from directly contacting the consumer with other offers (bypassing the lead specialist), and protecting the consumers from being inundated with unsolicited email offers. Furthermore, as will be described in more detail below, because each unique email address is associated with a consumer's data record and actual email address, as well as with a particular lender, any subsequent correspondence to that unique email address can be tracked by the lead specialist so that bona fide responses to the consumer can be passed-through to the consumer, and so that unsolicited, unauthorized offers or responses can be filtered. In addition to protecting the consumer, the lead specialist can track response to the unique email addresses to detect misuse of the lead information by lenders, and even identify specific lenders that are misusing that information.

Turning now to FIG. 5, with the consumer information and unique email address(es) sent to the lender(s) as described above, an exemplary method of receiving correspondence sent to one of the unique email addresses will be described with further reference to FIGS. 1-4. At block 60, an email addressed to one of the generated unique email addresses is received at the lead specialists email processing server. As detailed above, the lead specialist may control hundreds or thousands of domain names, and have sent consumer information relating to thousands of consumers to multiple lenders, with each of those having a unique email address that ultimately resolves to the lead specialist's email processing server.

At block 62, upon receipt of the email, the email processing server correlates that unique email address with corresponding consumer information data record (see FIG. 3), which provides the consumer's actual email address and the lender(s) that received the initial correspondence having the consumer information.

At block 64, various rules and filters are applied to the received email. Preferably, rules are first applied to determine if the email is legitimate (e.g., did it come from a lender to which consumer information had been sent?), if so, the email is forwarded or directed to the consumer at their actual email address. Additional rules are applied to determine if the received email is spam or junk email, or otherwise of no value, in which case the email may simply be deleted. It should be apparent that the rules necessarily identify the sender (e.g., via the “from:” field of the email) of the received email so that those senders can be tracked along with the received email.

Various filters are also applied to the received email to ascertain the origin, content, and other information in the email. For example a filter can be applied on the “from:” field of the email to determine the sender, to the domain name and/or IP address of the sender, to the subject line of the email, to the message body of the email, or a filter can determine a postal address within an email or a company or entity name. Any other desired criteria or information within the email can likewise be detected by a filter configured to detect that desired information.

Filters may be configured to run independently or in combination, so that, for example, and email with a particular keyword in the subject line and originating from a specific IP address can be identified. Any number of combinations and permutations of filters are envisioned, and are within the scope of the present invention. Filters may be used to isolate “good” emails and “bad” emails, i.e., good emails being those which are allowed and are then forwarded to the consumer's actual email address, and bad emails being those that are unauthorized or spam/junk emails.

The system and method of the present invention does not require that every consumer response be masked, but allows a lead specialist to mask emails for particular consumers (or groups of consumers) or for certain traffic sources, for example all responses from Gmail accounts, or all responses from a group of consumer email providers.

Thus, in combination with the unique email addresses, the system and method of the present invention allows email correspondence intended for a consumer to be tracked and filtered so that only authorized correspondence is ultimately forwarded or directed to the consumer. The system and method also allows a lead specialist to track usage of its lead information by lenders, and to identify misuse of that lead information.

It should be understood that while the claimed invention is described primarily with reference to an exemplary marketing campaign offered primarily through ESPs, the same targeting, tracking, and optimization may be employed in marketing campaigns conducted via text message, telephone, postal, or other delivery mediums and methods

Likewise, it should be understood that while the claimed invention is described with reference to consumer loan products, the invention is equally applicable to other vertical markets, such as insurance, mortgage, and auto loans. These and other variations are contemplated by and are within the scope of the present invention.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

1. A computer-implemented method for masking email addresses, comprising:
using at least one processor to:
receive a response to an offer from a consumer, said response comprising consumer information, including said consumer's email address;
generate a unique email address associated with said consumer information;
associate at least one lender name with said consumer information and said unique email address:
substitute said unique email for said consumer's email address in said consumer information to create a modified consumer information; and
forward said modified consumer information to a recipient.

2. The computer-implemented method of claim 1, wherein said at least one processor is further used to:
receive correspondence directed to said unique email address.

3. The computer-implemented method of claim 2, wherein said at least one processor is further used to:
filter said received correspondence according to predetermined criteria; and
delete or forward said received correspondence based on results of said filtering.

4. The computer-implemented method of claim 3, wherein said predetermined criteria includes: from field, originating IP address; domain name, subject, message content, and combinations thereof.

5. The computer implemented method of claim 1, wherein said processor is further operable to:
store said consumer information and unique email address in a database.

6. (canceled)

7. The computer-implemented method of claim 1 wherein said processor is further operable to:
associate and store said consumer information, said unique email address, and said at least one lender name in a database.

8. The computer-implemented method of claim 1, wherein said processor is further operable to:
receive correspondence directed to said unique email address; and
correlate and track correspondence associated with said at least one lender name.

9. A non-transitory computer-readable medium having instructions stored thereon for execution by a processor to perform a method for masking email addresses, the method comprising:
receiving a response to an offer from a consumer, said response comprising consumer information, including said consumer's email address;
generating a unique email address associated with said consumer information;
associating at least one lender name with said consumer information and said unique email address;
substituting said unique email for said consumer's email address in said consumer information to create a modified consumer information; and
forwarding said modified consumer information to a recipient.

10. The non-transitory computer-readable medium of claim 9, wherein the method further comprises:
receiving correspondence directed to said unique email address.

11. The non-transitory computer-readable medium of claim 10, wherein the method further comprises:
filtering said received correspondence according to predetermined criteria; and
deleting or forwarding said received correspondence based on results of said filtering.

12. The non-transitory computer-readable medium of claim 11, wherein said predetermined criteria includes: from field, originating IP address; domain name, subject, message content, and combinations thereof.

13. The non-transitory computer-readable medium claim 9, wherein the method further comprises:
storing said consumer information and unique email address in a database.

14. (canceled)

15. The non-transitory computer-readable medium of claim 9 wherein the method further comprises:
associating and storing said consumer information, said unique email address, and said at least one lender name in a database.

16. The non-transitory computer-readable medium of claim 9, wherein the method further comprises:
receiving correspondence directed to said unique email address; and
correlating and tracking correspondence associated with said at least one lender name.

17. A system for masking email addresses, comprising:
at least one processor operable to:
receive a response to an offer from a consumer, said response comprising consumer information, including said consumer's email address;
generate a unique email address associated with said consumer information;
associate at least one lender name with said consumer information and said unique email address;
substitute said unique email for said consumer's email address in said consumer information to create a modified consumer information; and
forward said modified consumer information to a recipient.

18. The system of claim 17, wherein said at least one processor is further used to:
receive correspondence directed to said unique email address.

19. The system of claim 18, wherein said at least one processor is further used to:
filter said received correspondence according to predetermined criteria; and
delete or forward said received correspondence based on results of said filtering.

20. The system of claim 19, wherein said predetermined criteria includes: from field, originating IP address; domain name, subject, message content, and combinations thereof.

21. The system of claim 17, wherein said processor is further operable to:
store said consumer information and unique email address in a database.

22. (canceled)

23. The system of claim 17 wherein said processor is further operable to:
associate and store said consumer information, said unique email address, and said at least one lender name in a database.

24. The system of claim 17, wherein said processor is further operable to:
receive correspondence directed to said unique email address; and
correlate and track correspondence associated with said at least one lender name.

25. A computer-implemented method for masking email addresses, comprising:
using at least one processor to:
receive a communication from a consumer, said communication comprising consumer information, including said consumer's email address;
generate a unique email address correlated with said consumer's email address for sending and receiving communication associated with said consumer; and
associate at least one lender name with said consumer information and said unique email address.

26. The computer-implemented method of claim 25, wherein said unique email address comprises a randomly generated email address.

27. The computer-implemented method of claim 25, wherein said unique email address comprises a one-time-use email address.
